(19) United States
(12) Patent Application Publication
(10) Pub. No.: US 2013/0172176 A1
(43) Pub. Date: Jul. 4, 2013

(54) Low-Alkali Catalyst Material and Process for Preparation Thereof

(71) Applicants: Bernd Proft, Neukirchen-Vluyn (DE); Regina Optehostert, Moers (DE); Ulrich Gesenhues, Moers (DE); Bernd Rohe, Moers (DE); Sonja Grothe, Oberhausen (DE)

(72) Inventors: Bernd Proft, Neukirchen-Vluyn (DE); Regina Optehostert, Moers (DE); Ulrich Gesenhues, Moers (DE); Bernd Rohe, Moers (DE); Sonja Grothe, Oberhausen (DE)

(73) Assignee: SACHTLEBEN CHEMIE GMBH, Duisburg (DE)

(21) Appl. No.: 13/805,375

(22) PCT Filed: Jun. 25, 2011
(86) PCT No.: PCT/DE2011/075150

§ 371 Date: Jan. 22, 2013

(30) Foreign Application Priority Data
Jun. 29, 2010 (DE) 10 2010 030 685.1

(51) Int. Cl. B01J 23/30; B01J 23/04

(52) U.S. Cl. CPC B01J 23/30; B01J 23/04
USPC 502/242

(57) ABSTRACT

A catalyst material, more specifically a catalyst material based on TiO2/SiO2 in particulate form having a content of metal in the form of the metal oxide or metal oxide precursor, to processes for preparation thereof and to the use thereof in chemical catalysis, especially for removal of pollutants, such as nitrogen oxides from combustion gases

The invention relates to a catalyst material, more precisely a low-alkali-metal catalyst material based on SiO₂/TiO₂, a process for the production thereof and the use thereof for producing catalysts, in particular for the removal of pollutants, in particular nitrogen oxides, from combustion gases.

Nitrogen oxides formed in combustion lead to irritation and damage to the respiratory organs (especially in the case of nitrogen dioxide), and formation of acid rain due to formation of nitric acid. In the removal of nitrogen oxides from flue gas (also known as DeNOx), nitrogen oxides such as nitrogen monoxide (NO) and nitrogen oxides (NOₓ) are, for example, removed from the offgas of coal-fired or gas turbine power stations.

As measures for removing nitrogen oxides from the offgases, reductive processes such as selective catalytic processes (selective catalytic reduction, SCR) are known in the prior art. The term SCR refers to the technique of selective catalytic reduction of nitrogen oxides in offgases from firing plants, domestic waste incineration plants, gas turbines, industrial plants and engines.

Many such catalysts contain TiO₂, with the TiO₂ acting as catalyst itself or acting as cocatalyst in combination with transition metal oxides or noble metals. The chemical reaction over the SCR catalyst is selective, i.e. the nitrogen oxides (NO, NO₂) are preferentially reduced while undesirable secondary reactions (for example the oxidation of sulfur dioxide to sulfur trioxide) are largely suppressed.

There are two types of catalysts for the SCR reaction. One type consists essentially of titanium dioxide, vanadium pentoxide and tungsten oxide. The other type is based on a zeolite structure. Further metal components are also added to the two systems in the prior art.

In the case of TiO₂—WO₃—V₂O₅ catalysts, the V₂O₅ serves primarily as catalytically active species on WO₃-coated TiO₂ (in the anatase modification). The WO₃ coating on the TiO₂ is intended to function as barrier layer to prevent diffusion of vanadium into the TiO₂ and the associated decrease in activity and formation of rutile.

According to the prior art in U.S. Pat. No. 4,085,193, WO₃-coated TiO₂ is proposed for catalytic applications, including as DeNox catalyst. The process known therefrom is based on addition of tungsten components to metatitanic acid and subsequent calcination to set the surface area to about 100 m²/g. A disadvantage of these catalysts is the thermal stability up to only 650° C.

A catalyst which is described in U.S. Pat. No. 5,922,294 and in which TiO₂ is present in the anatase modification is stable up to 800° C., but the production process involving cohydrolysis of titanium alkoxides and aluminum alkoxides (sol-gel process) has the disadvantage that undesirable, because they are expensive, metal-organic compounds and organic solvents have to be employed. Similar considerations apply to the process for the system TiO₂/SiO₂ described in EP 0826410.

EP 0668100 describes a process for producing a TiO₂/SiO₂ catalyst by addition of an acidic solution containing a silicon compound and a titanium compound dissolved therein to the solution of a basic compound in order to bring about coprecipitation.

DE 3619337 describes the preparation of a TiO₂/SiO₂ powder by mixing an aqueous titanium sulfate solution with an ammonium-containing, aqueous SiO₂ sol. The precipitation product is washed, dried and calcined and used for producing a catalyst material having a content of vanadium and copper.

To produce mesoporous TiO₂ or TiO₂/SiO₂ catalysts, TiO₂ or TiO₂/SiO₂ powders are mixed with materials which can be burnt out (e.g. methylcellulose), shaped and subsequently calcined according to the processes known from EP 0516262 and EP 1063002.

A mesoporous, pulverulent TiO₂/SiO₂ material is also described in WO0114054.

To produce this material, the Ti is precipitated in the form of a titanium hydroxide and an SiO₂ component is added after precipitation of the titanium hydroxide with an SiO₂ content in the end product of not more than 18%.

A further catalyst system is disclosed in EP 1533027. There, a process for producing a TiO₂-containing catalyst or catalyst support, in which an aqueous, titanium-containing solution is added to a suspension of a finely divided, inorganic support material in water, with TiO₂ being precipitated as titanium oxide hydrate on the inorganic support, is described.

Although some of the materials known in the prior art already have acceptable properties for the desired purpose, there is a further need to provide a TiO₂-containing catalyst or catalyst support which brings further improved properties for suitability as DeNOₓ catalyst.

The inventors have now found that the use of nanosize SiO₂ particles as are present in silica sols for the production of TiO₂/SiO₂ enable the particle size of the SiO₂ in the product to be set at at least 5-30 nm. To give the particles a very high proportion of the specific surface area of TiO₂ for use in catalysis, the TiO₂ particles should be stabilized against particle growth and rutile formation by coalescence by incorporation of as little as possible SiO₂ in between. For this purpose, it is also advantageous, as the inventors have recognized, to produce smaller SiO₂ particles than are commercially available and this can advantageously be achieved from genuine silicate solutions. Use of the cheapest solution, namely water glass, is ruled out since the alkali metal can be washed out only incompletely or with an extremely high outlay, especially by means of large amounts of washing water, from the TiO₂/SiO₂ product. For this reason, the inventors propose the use of low-alkali-metal starting materials in ammoniacal solution, which can be obtained either by ion exchange from the corresponding alkali metal salts or by reaction of silica/SiO₂ in sol or gel form with ammonia. In contrast to the processes known in the prior art, no Ti or Si compounds containing organic radicals R, for example —Si—OR or —Ti—OR where R=alkyl, but merely inorganic compounds are used as starting materials. The process of the invention is therefore particularly environmentally friendly.

Accordingly, the object of the invention is achieved by provision of a process for producing a low-alkali-metal TiO₂-containing catalyst material, in which a Ti-containing solution having a concentration of dissolved Ti of, converted to an oxide basis, from 10 to 250 g of TiO₂ per liter of solution and a low-alkali-metal solution of hydrated precursors of one or more Si-oxygen compounds are reacted in the presence of ammonia at a pH of from 4.5 to 6.5 and the product obtained is filtered off, washed and subjected to a final treatment.

No material like the material according to the invention, which combines the advantageous properties of a thermally stable specific surface area of 50-300 m²/g, a very low Na content of <300 mg/kg and a high mesopore volume of >0.3 cm³/g, is known from the prior art.

The material of the invention preferably has a mesopore volume of >0.35 cm³/g, more preferably >0.5 cm³/g, particularly preferably >0.7 cm³/g, and a specific surface area of 90-200 m²/g.

Here, a specific surface area is considered by the inventors to be thermally stable and thus well-suited for the desired use when the specific surface area changes by less than 30% as a result of heating at T=650° C. for 50 hours. According to the invention, all measures which are referred to here as ignition, heat treatment or calcination are carried out under an air atmosphere unless indicated otherwise.

According to a further aspect of the invention, one or more Si-oxygen compounds (ammonium silicate, silicic acid, silica sol or silica gel) are used as hydrated precursors and are reacted with the Ti-containing solution in the presence of ammonia at a pH of from 4.5 to 6.5. According to the invention, the synthesis, i.e. essentially the precipitation reaction of this material, is preferably carried out in an intensively stirred reactor with immersed, slow and simultaneous addition of the starting materials for the Ti component and Si component and NH₃ to adjust and regulate the pH.

For the purposes of the invention, intensive stirring is turbulent stirring which can be achieved, for example, in a reactor with baffles and/or centric stirring by means of a cage stirrer. Eccentric stirring is also possible. Suitable stirrer types are cage stirrers, gyro stirrers, trapezoidal stirrers, MIK stirrers, Intermig stirrers, sigma stirrers, propeller stirrers, inclined-blade stirrers, impeller stirrers or crossed-beam stirrers. Intensive stirring can also be achieved by means of a high-speed stirrer or Ultraturrax dispersion.

A further aspect of the invention provides a process for producing a low-alkali-metal high-temperature-stable TiO₂-containing catalyst material, in which a Ti-containing solution having a concentration of dissolved Ti of, converted to an oxide basis, from 10 to 250 g of TiO₂ per liter of solution and a low-alkali-metal solution of hydrated precursors of one or more Si-oxygen compounds in the form of ammonium silicate are reacted in the presence of ammonia at a pH of from 4.5 to 6.5 and the product obtained is filtered off, washed and subjected to a thermal treatment, where the ammonium silicate has preferably been prepared from an alkali metal silicate by ion exchange. Washing of the product optionally takes place at pH values close to the isoelectric point (IEP) of the catalyst material of the invention. For this purpose, the pH of the product suspension is set by means of acid (e.g. sulfuric acid) or alkali (e.g. aqueous ammonia) to a pH close to the IEP before washing.

For the present purposes, the expression low-alkali-metal solution of hydrated precursors refers to compounds which are formally obtained by addition of one or more H₂O molecules onto the Si-oxygen compound and in which the content of alkali metal such as sodium or potassium in the finished product is generally less than 500 ppm, preferably less than 300 ppm and particularly preferably less than 150 ppm.

In the process of the invention, the Ti-containing solution having a concentration of dissolved Ti of, converted to an oxide basis, from 10 to 250 g of TiO₂ per liter of solution and a low-alkali-metal solution of hydrated precursors of one or more Si-oxygen compounds are reacted in the presence of ammonia at a pH of from 4.5 to 6.5, preferably 5-6, and further hydrated precursors are formed, preferably in conjunction with a ripening step, in the form of a precipitation mixture which is generally present as a dispersion or suspension and can then be passed either directly or after filtration and washing in the form of the filter cake to a thermal treatment.

The latter hydrated precursors can also be nonstoichiometric, e.g. metatitanic acid corresponds only approximately to the formula TiO(OH)₂ (cf. U. Gesenhues, Chem. Eng. Technol. 24 (2001) 685).

To carry out the precipitation, the low-alkali-metal solutions of hydrated precursors of one or more Si-oxygen compounds, the salts of metals or semi-metals and/or Ti can be combined simultaneously or in succession in a stirred vessel. Here, the pH can be maintained by simultaneous further addition of ammonia in the abovementioned ranges which ensure precipitation. In general, the precipitation is carried out at a pH of not more than 6.5 and not less than 4.5; in general, the pH in the precipitation of silica has to be below 9 and in the case of titanium oxide hydrate has to be above 2. It is also possible for solutions of the salts of Ti and Si to be initially charged and then brought to the appropriate pH.

According to the invention, a solution of titanyl sulfate or titanium sulfate, calculated as TiO₂, in a concentration of from 10 to 250 g/l, preferably from 50 to 200 g/l, particularly preferably from 80 to 120 g/l, of solution is preferably used as Ti-containing solution.

The filter cake obtained from the precipitation mixture can be subjected, in one form of the thermal treatment, to ignition, preferably in the temperature range from 600 to 900° C., preferably 700° C., preferably for a period of up to 8 hours, preferably 3 hours.

In another process step for the thermal treatment, the hydrated precursors can be subjected to a hydrothermal treatment. Thus, the process of the invention can, in particular, comprise, as thermal treatment, a hydrothermal treatment in which the product obtained is introduced as precipitation mixture of the precursors of TiO₂ and Si-oxygen compounds together with water into a pressure vessel (autoclave) and maintained for a period of from one hour to 5 days at temperatures of >100° C., in particular in the temperature range from 160° to 180° C., in particular at 170° C., with a hold time of from 3 to 5 hours, in particular 4 hours. This thermal treatment can be carried out before or after filtration and washing.

The catalyst materials which can be obtained by the process of the invention can also be doped and/or after-treated with metal oxides and/or metal oxide precursors, e.g. with SnO₂, CeO₂, VOₓ, CrOₓ, MoOₓ, WOₓ, MnOₓ, FeOₓ and NiO, CoOx, among which VOₓ and WOₓ are preferred. For the purposes of the invention, metal oxide precursors thereof are, for example, hydrated precursors of oxides, hydroxides, etc., which are transformed thermally into the metal oxides.

A preferred embodiment of the process comprises coating with a metal oxide or metal oxide precursor by addition of the metal salt component before the thermal treatment, i.e. during or after precipitation of the hydrated Si-oxygen compounds at pH values of pH<7 or after filtration and washing. Tungsten salts are preferably used as metal salt components. Particular preference is given to carrying out coating with a tungsten oxide precursor by addition of a tungsten salt after precipitation before a hydrothermal treatment. As a result of this preferred mode of operation, the proportion of soluble tungsten is significantly reduced and the specific surface area and the pore volume are increased.

More precisely, this preferred process for coating with the tungsten oxide precursor comprises the following reaction steps. Firstly, precipitation from titanyl sulfate solution and ammonium silicate solution is carried out using aqueous ammonia at pH 3-6. This can optionally be followed by a ripening phase at 20-80° C. for 0.5-6 hours. The addition of 10-30% by weight of WO₃ based on TiO₂/SiO₂, e.g. preferably in the form of ammonium metatungstate, follows. This can optionally be followed by another ripening phase at 20-80° C. for 0.5-6 hours. A HT treatment at from 170 to 180° C. (˜10 bar), for up to 24 hours, preferably 4 hours, follows. Furthermore, filtration and washing and reslurrying are carried out, followed by drying, e.g. spray drying. This is optionally followed by ignition. If necessary, milling can follow.

Thus, a low-alkali-metal catalyst material based on TiO₂—SiO in particle form having an alkali metal content of less than 300 ppm can, in particular, be produced according to the invention. The catalyst material of the invention can be used as catalyst precursor, as catalyst support and as catalyst. The catalyst material of the invention is highly suitable for producing an offgas catalyst and for use in chemical catalysis processes.

The catalyst material of the invention has, compared to the materials known from the prior art, a higher pore volume of >0.3 cm³/g, in particular in the range from 0.35 to 1.0 cm³/g, which in turn leads to a higher catalytic activity. These measurement data relate to the micropores and mesopores.

In addition, the pores of the catalyst material of the invention have a narrow pore size distribution (measured by means of nitrogen porosimetry to determine the micropores and mesopores) in the range from 3 to 50 nm. In general, 90% of the pore sizes of the catalyst material of the invention are in this size range.

For the purposes of the description of the invention, the definition of the pore sizes routine in the literature, as is described, for example, in “Fundamentals of Industrial Catalytic Processes”, R. J. Farrauto, C. H. Bartholomew, Blackie Academic & Professional, 1997, page 78, is used. This document defines pores having diameters of d_{Pore}>50 nm as macropores, pores having d_{Pore}=3-50 nm as mesopores and pores having d_{Pore}<3 nm as micropores.

The pore size distribution itself influences the shape selectivity and more rapid diffusion of the gas into and from the particles is made possible as a result of larger pore radii. This at the same time leads to a low tendency for pores to become blocked due to the larger pore radii. In addition, the interior walls of these pores can more readily be treated with a metal compound of W or V and thus be coated with WO₃ and/or V₂O₅. Thus, in the case of the materials of the invention, no crystalline tungsten species are detected by means of X-ray diffraction up to a loading of 25% by weight of WO₃.

As a result of the reduced particle size of the catalyst material of the invention, the accessible surface area is increased and improved dispersibility of the particles is ensured. The particle size after dispersion by means of an ultrasonic probe is 0.1-3.0 μm.

To determine the particle sizes after dispersion, the pulverulent catalyst material is dispersed in water by means of an ultrasonic probe (at maximum power, manufacturer: Branson Sonifier 450, using an increase in amplitude by means of a Booster Horn “Gold”, ½″ titanium tube having exchangeable, flat working tip) for 5 minutes. The particle size determination is carried out by means of laser light scattering.

It has surprisingly been found that a catalyst material produced according to the invention has a high specific surface area and contains TiO₂ in the anatase form, with the specific surface area and the anatase form being stable up to at least 650° C. The BET surface area is reduced by a maximum of 30% when subjected to a temperature of 650° C. for 50 hours.

The invention is illustrated by the following experiments and comparative experiments.

### PRODUCTION EXAMPLES ACCORDING TO THE INVENTION

### Production Example 1

A commercial water glass solution having a content of dissolved silicate corresponding to 360 g of SiO₂/l and a molar ratio of SiO₂/Na₂O of 3.45 was diluted to 100 g of SiO₂/l. An ammonium silicate solution containing 90 g of SiO₂/l was then produced therefrom via an ammonium sodium silicate solution as intermediate by the two-stage process reported in H. Weldes, Ind. Eng. Chem. Prod. Res. Develop. 9 (1970) 249-253 using the NH₄⁺-loaded cation exchanger Amberlite IR-120 (Rohm & Haas Comp.). Its molar ratio of (NH₄)₂O/Na₂O was set to a value of 8 or 25 (checked analytically) via the amount of aqueous NH₃ solution in the first step and the amount of ion exchanger in the second step, as per the directions in H. Weldes. The molar ratio SiO₂/(NH₄)₂O of the solutions obtained was only a little below the initial molar ratio of SiO₂/Na₂O, and their pH was 10.1-10.2.

This ammonium silicate solution was then used according to the invention instead of water glass as in example 6 of EP 1533027. Simultaneous addition of the ammonium silicate solution having the molar ratio of (NH₄)₂O/Na₂O of 8 or 25 and TiOSO₄ solution to an initial charge of water and addition of aqueous NH₃ solution to maintain a pH of 5-6 in the initial charge resulted in precipitation of a fine mixture of precursors of TiO₂ and SiO₂. For this purpose, 5 l of deionized water were placed in a 74 l stainless steel vessel having a heating coil, propeller stirrer and discharge valve. Over a period of 180 minutes, 30.0 l of the ammonium silicate solution prepared above containing 90 g of SiO₂/l and 12.1 l of TiOSO₄ solution having a Ti content of, converted to an oxide basis, 110 g of TiO₂/l were introduced simultaneously via peristaltic pumps and a pH of 5-6 was maintained by addition of aqueous NH₃ solution. After ripening for 1 hour at 80° C. while stirring and heating, the precipitate was filtered off on a suction filter and washed only with 10 l of warm deionized water. The filter cake obtained contained 80 or 30 ppm of Na after drying at 110° C., depending on the molar ratio of (NH₄)₂O/Na₂O in the ammonium silicate solution used.

The filter cake produced according to the invention was processed further and examined as follows:

After ignition at 900° C. for 4 hours, the specific surface area (BET) was 125 m²/g, the pore volume (N₂ porosimetry) was 0.43 cm³/g, the proportion of rutile in the TiO₂ was 0% and the Scherrer crystallite size of the anatase was 26 nm, independently of the ammonium silicate solution used.

As an alternative to ignition, hydrothermal treatment (HT) at 180° C., corresponding to 10 bar, for 4 hours and drying as in example 8 of DE 103 52 816 A1 gave a specific surface area (BET) of 165 m²/g, a pore volume (N₂ porosimetry) of 0.54 cm³/g, likewise 0% of rutile and a Scherrer crystallite size of the anatase of 17 nm, likewise independently of the ammonium silicate solution used.

In addition, the thermal stability of the ignited or HT-treated product from use of the ammonium silicate solution richer in Na was tested at 650° C. for 50 hours. The values of the previously measured 4 parameters no longer changed in the ignited product as a result, while in the case of the HT-treated product the BET decreased by 15 m²/g and the pore volume decreased by 0.04 cm³/g and the rutile content remained at 0% and the anatase crystallite size increased to 21 nm. These changes are small, and both materials can be considered to be thermally stable.

### Production Examples 2 and 3

In the same way as in production example 1, products according to the invention containing 15 and 7.5% of SiO₂ were produced using the ammonium silicate solution having the molar ratio of (NH₄)₂O/Na₂O=8 by reducing the amount of ammonium silicate compared to production example 1. The products were tested as before.

The properties of the products from production examples 1 to 3 are shown in table 1.

TABLE 1

| | | | | | | | Scherrer- |
|---|---|---|---|---|---|---|---|
| | | After | | | | | crystallite |
| | | precipitation, | ppm | Spec. s. | | % of | size of |
| | % of | filtr. and | of | area | Pore vol. | rutile in | anatase |
| Ex. | SiO₂ | washing | Na | [m²/g] (a) | [cm³/g] (a) | the TiO₂ (a) | [nm] (a) |
| 1 (b) | 67 | Ignition | 85 | 125 (125) | 0.43 (0.43) | 0 (0) | 26 (26) |
| | | HT and | 90 | 165 (150) | 0.54 (0.50) | 0 (0) | 17 (21) |
| | | drying | | | | | |
| 2 | 15 | Ignition | 25 | 85 (80) | 0.35 (0.32) | 0 (0) | 30 (32) |
| | | HT and | 30 | 110 (95) | 0.47 (0.43) | 0 (0) | 24 (29) |
| | | drying | | | | | |
| 3 | 7.5 | Ignition | 20 | 50 (45) | 0.14 (<0.10) | 0.4 (1.1) | 42 (48) |
| | | HT and | 20 | 75 (50) | 0.21 (0.17) | 0.2 (0.8) | 31 (39) |
| | | drying | | | | | |

(a) Value in parentheses: after additional ignition at 650° C. for 50 hours
(b) Values in parentheses for product from use of the ammonium silicate solution richer in Na

As the results demonstrate, ammonium silicate solutions having a very low molar ratio of (NH₄)₂O/Na₂O can be used in the TiO₂/SiO₂ materials containing less than 67% of SiO₂ which are nowadays preferred by catalyst manufacturers in order to meet the requirements in respect of the Na content of the product (<100 ppm of Na), which is economically advantageous.

Furthermore, with increasing TiO₂ content and the same production conditions, the specific surface area and the pore volume and also their stability in high-temperature uses of the product decrease, and the proportion of rutile in the TiO₂ becomes greater than 0, which is likewise undesirable. The results in the table show that the product should have an SiO₂ content of at least 7.5%, preferably at least 10-15%, for catalysis at high temperatures.

### Production Example 4

In a similar way to example 1, the following starting materials:
Titanyl sulfate solution containing 112 g of TiO₂/l
Ammonium silicate solution having an SiO₂ content of 90 g of SiO₂/l Aqueous ammonia, 15% of NH₃XH₂O
   were reacted as follows:
1. Precipitation of the titanyl sulfate solution and ammonium silicate solution by means of aqueous ammonia at pH 5-6 with high-speed stirrer dispersion at 1000-1800 rpm
2. Ripening at 80° C. for 1 hour
3. HT treatment at 180° C. (=10 bar) for 4 hours
4. Filtration and washing
5. Spray drying

### Production Example 5

In a similar way to example 1, the following starting materials:
Titanyl sulfate solution containing 112 g of TiO₂/l
Ammonium silicate solution having an SiO₂ content of 90 g of SiO₂/l Aqueous ammonia, 15% of NH₃XH₂O
   were reacted as follows:
1. Precipitation of the titanyl sulfate solution and ammonium silicate solution by means of aqueous ammonia at pH 5-6 with high-speed stirrer dispersion at 1000-1800 rpm
2. Ripening at 80° C. for 1 hour
3. HT treatment at 180° C. (=10 bar) for 4 hours
4. Filtration and washing
5. Spray drying

The catalyst materials produced in the production examples 4 and 5 were examined. The results of the analyses are shown in table 2.

Titanium, oxygen and silicon were determined by X-ray fluorescence analysis and the content of TiO₂ and SiO₂ was calculated therefrom. The values are at the expected level. Sodium and potassium were determined by atomic absorption spectroscopy. The limiting values were achieved for both samples. In addition, the content of sulfate and of ammonium was determined.

The Scherrer particle size was determined by means of an X-ray diffraction pattern. Both catalyst materials were present in the anatase modification. Measurement of the specific surface area by the BET method (5P.) gave a value of about 120 m²/g for both samples.

The pore volume was likewise determined. The pore volume (total) and the pore diameter are listed in table 2. Both samples have a high pore volume.

The thermal stability of the two samples was tested at 650° C. for 50 hours. The specific area after this treatment was about 100 m²/g in the case of both samples. Both were present as anatase and have a Scherrer particle size of 10 nm. The abovementioned values are summarized in table 2. Both samples are thermally stable.

TABLE 2

| Parameter | Example 4 | Example 5 |
|---|---|---|
| Ti (TiO₂) by XRF % | 52 (86.7) | 52 (8.7) |
| O by XRF % | 42 | 42 |
| Si (SiO₂) by XRF % | 5.7 (12.2) | 5.7 (12.2) |
| Na (AAS) mg/kg | <50 | <50 |
| K (AAS) mg/kg | <50 | <50 |
| Particle size (Scherrer) nm | 11 | 10 |
| Spec. surface area | 118 | 119 |
| (5 point BET) [m²/g] | | |
| Pore volume (total) cm³/g | 0.842 | 0.986 |
| Pore diameter (average) nm | 28.5 | 33.1 |
| Thermal stability | | |
| Spec. surface area | 100 m²/g | 105 m²/g |
| after 50 h at 650° C. | Anatase | Anatase |
| | 10 nm | 10 nm |

### Production Example 6

In a similar way to example 1, the following starting materials:
Titanyl sulfate solution containing 111 g of TiO₂/l
Ammonium silicate solution having an SiO₂ content of 90 g of SiO₂/l Aqueous ammonia, 15% of NH₃XH₂O
   were reacted as follows:
1. Precipitation of the titanyl sulfate solution and ammonium silicate solution by means of aqueous ammonia at pH 5-6 in a reactor having baffles with intensive stirring by means of a cage stirrer at 1000 rpm, with immersed addition of the starting solutions
2. Ripening at 80° C. for 1 hour, decantation after settling over night
3. W treatment with 15% by weight of WO₃ by addition of an ammonium metatungstate solution having a WO₃ content of 30% by weight
4. HT treatment at 170-180° C. (=10 bar) for 4 hours
5. Filtration and washing
6. Reslurrying
7. Spray drying

### Production Example 7

In a similar way to example 6, the following starting materials:
Titanyl sulfate solution containing 111 g of TiO₂/l
Ammonium silicate solution having an SiO₂ content of 90 g of SiO₂/l Aqueous ammonia, 15% of NH₃XH₂O
   were reacted as follows:
1. Precipitation of the titanyl sulfate solution and ammonium silicate solution by means of aqueous ammonia at pH 5-6 in a reactor having baffles with intensive stirring by means of a cage stirrer at 1000 prm, with the immersed addition of the starting solutions
2. Ripening at 80° C. for 1 hour
3. Filtration and washing
4. Reslurrying and W treatment with 12% by weight of WO₃ by addition of an ammonium metatungstate solution having a WO₃ content of 30% by weight
5. Spray drying
6. Ignition at 650° C. in a furnace for 2 hours

### Production Example 8

In a similar way to example 6, the following starting materials:
Titanyl sulfate solution containing 111 g of TiO₂/l
Ammonium silicate solution having an SiO₂ content of 90 g of SiO₂/l Aqueous ammonia, 15% of NH₃XH₂O
   were reacted as follows:
1. Precipitation of the titanyl sulfate solution and ammonium silicate solution by means of aqueous ammonia at pH 5-6 in a reactor having baffles with intensive stirring by means of a cage stirrer at 1000 prm, with the immersed addition of the starting solutions
2. Ripening at 80° C. for 1 hour
3. Filtration and washing
4. Reslurrying and W treatment with 21% by weight of WO₃ by addition of an ammonium metatungstate solution having a WO₃ content of 30% by weight
5. Spray drying
6. Ignition at 650° C. in a furnace for 2 hours

The catalyst materials produced in this way were examined as described above and the results are shown in table 3.

To determine the average particle sizes D50 after dispersion, the pulverulent catalyst material is dispersed in water by means of an ultrasonic probe (at maximum power, manufacturer: Branson Sonifier 450, using an increase in amplitude by means of Booster Horn “Gold”, ½″ titanium tube having an exchangeable, flat working tip) for 5 minutes. The particle size determination is carried out by means of laser light scattering. Here, the average particle size D50 reported is the D50 median of the volume distribution in percent by volume.

It was able to be demonstrated by X-ray diffraction that crystalline tungsten oxide species are not present in any of the examples 6-8.

TABLE 3

| | Example 6 | Example 7 | Example 8 |
|---|---|---|---|
| Parameter | HT treatment | Calcination | Calcination |
| Ti (TiO₂) by XRF % | 45 (75.1) | 46 (76.7) | 41 (68.4) |
| Si (SiO₂) by XRF % | 4.3 (9.2) | 4.8 (10.3) | 4.4 (9.4) |
| W (WO3) by XRF | 12 (15.1) | 9.9 (12.5) | 17 (21.4) |
| Na (AAS) mg/kg | 30 | 33 | 30 |
| Particle size (Scherrer) nm | 11 | 9 | 8 |
| Modification | Anatase | Anatase | Anatase |
| Spec. surface area | 158 | 96 | 130 |
| (5 point BET) [m²/g] | | | |
| Pore volume (total) cm³/g | 0.643 | 0.414 | 0.49 |
| Pore diameter (average) nm | 16.3 | 17.3 | 15.1 |
| d50 data μm | 0.92 | 1.68 | 1.2 |
| B90/10 μm | 1.3 | 3.1 | 1.9 |
| Thermal stability | | | |
| Spec. surface area | 95.6 | 81.4 | 108.5 |
| after 50 h at 650° C. | | | |

### Comparative Example 1

5 l of H₂O were placed in a 74 l stainless steel vessel provided with heating coil, stirrer and discharge valve. Over a period of 180 minutes, 13.525 l of Na₂SiO₃ solution having an Si content corresponding to 345 g of SiO₂/1 and 20.655 l of TiOSO₄ solution having a Ti content of, converted to an oxide basis, 110 g of TiO₂/l were simultaneously added by means of peristaltic pumps. During the addition, the pH was maintained at from 5 to 6 by addition of 291 of 10% strength aqueous NH₃ solution. The temperature rose to 40° C. as a result of the heat of reaction. The mixture was aged at 80° C. for 1 hour while stirring and heating. The mixture now had a solids content, calculated as oxides, of 101 g/l. The precipitate was then filtered off with suction and washed with 14 l of warm water and 14 l of warm (NH₄)₂SO₄ solution (concentration: 84 g/l). The filter cake was dried at 110° C. for 12 hours and ignited at 800° C. in a rotating fused silica bulb with gas extraction, which was located in a chamber furnace, for 4 hours. This was followed by further ignition at 900° C. for 11 hours and another ignition at 900° C. for 13 hours. The results are shown in the table 4. The product contained from 600 to 700 ppm of Na.

### Comparative Example 2

A washed filter cake of the mixture of precursors of TiO₂ and Al₂O₃ or SiO₂ produced in-house in an amount corresponding to 100 g of solid were each treated with 800 ml of deionized water at 180° C. at 10 bar in a 2 l steel autoclave for 2, 4 and 6 hours in each case, then filtered off, washed and dried. Examination of the products showed that the properties barely changed after 2 to 4 hours and then no longer changed. The results after hydrothermal treatment for 6 hours are shown in table 4.

TABLE 4

| | | | | | | Scherrer |
|---|---|---|---|---|---|---|
| | | | Spec. | | % of | crystallite |
| | | | surface | | rutile | size of |
| Comparative | | ppm of | area | Pore vol. | in the | anatase |
| example | | Na | [m²/g] | [cm³/g] | TiO₂ | [nm] |
| 1 | Ignition | 600-700 | 129-141 | 0.47-0.51 | 0 | 23 |
| 2 | HT | 600-700 | 186 | | 0 | 8 |

As can be seen from a comparison of the results of the production examples and the comparative examples, the materials according to the invention have improved properties, especially in respect of the alkali metal content.

1. A catalyst material comprising:
TiO₂—SiO₂ in particle form having an alkali metal content of less than 300 ppm and a specific BET surface area of 50-300 m²/g,
wherein the catalyst material comprises the TiO₂ in anatase form and has a mesopore volume of greater than 0.35 cm³/g, measured by nitrogen porosimetry, and the specific surface area is reduced by not more than 30% on thermal stressing at 650° C. for 50 hours.

2. The catalyst material based on TiO₂—SiO₂ as claimed in claim 1 having a mesopore volume of greater than 0.5 cm³/g, measured by nitrogen porosimetry.

3. The catalyst material based on TiO₂—SiO₂ as claimed in claim 1 having a specific BET surface area of 90-200 m²/g.

4. The catalyst material based on TiO₂—SiO₂ as claimed in claim 1 further comprising a content of metal oxide and/or metal oxide precursor.

5. The catalyst material based on TiO₂—SiO₂ as claimed in claim 4 which further comprises vanadium oxide, tungsten oxide, or precursors thereof.

6. A process for producing the low-alkali-metal catalyst material as claimed in claim 1 comprising:
reacting 1) a Ti-containing solution in the form of a titanyl sulfate solution or titanium sulfate having a concentration of dissolved Ti of, converted to an oxide basis, from 10 to 250 g of TiO₂ per liter of solution and 2) a low-alkali-metal solution of hydrated precursors of one or more Si-oxygen compounds in the presence of ammonia; and
filtering off and washing the obtained product; and
subjecting the product to a thermal treatment and optionally drying,
wherein the hydrated precursors of Si-oxygen compounds comprise silicic acid, silica sol, silica gel or ammonium silicate.

7. The process as claimed in claim 6, wherein the Ti-containing solution comprises a solution of titanyl sulfate.

8. The process as claimed in claim 6, wherein the thermal treatment comprises ignition of the product obtained.

9. The process as claimed in claim 6, wherein the thermal treatment comprises a hydrothermal treatment in which the product obtained is introduced as precipitation mixture of precursors of TiO₂ and Si-oxygen compounds together with water into a pressure vessel and maintained at temperatures of greater than 100° C. for a period of from 1 hour to 5 days.

10. The process as claimed in claim 6, wherein a compound of a metal is added during the course of the process.

11. The process as claimed in claim 10, wherein at least one compound comprising ammonium vanadate or ammonium tungstate is added as the compound of a metal.

12. The process as claimed in claim 11, wherein the addition of the metal compound is carried out before the hydrothermal treatment.

13-14. (canceled)

15. The catalyst material based on TiO₂—SiO₂ as claimed in claim 1 having a mesopore volume of greater than 0.7 cm³/g measured by nitrogen porosimetry.

16. An offgas catalyst comprising a catalyst material as claimed in claim 1.

17. A photocatalyst comprising a catalyst material as claimed in claim 1.
